(19) United States
(12) Patent Application Publication
(10) Pub. No.: US 2026/0166962 A1
(43) Pub. Date: Jun. 18, 2026

(54) REFRIGERANT LEAKAGE RESPONSE DEVICE AND METHOD

(71) Applicants: Hyundai Motor Company, Seoul (KR); Kia Corporation, Seoul (KR)

(72) Inventors: Jeawan KIM, Hwaseong-Si (KR); Jungmo YU, Hwaseong-Si (KR)

(21) Appl. No.: 19/330,141

(22) Filed: Sep. 16, 2025

(30) Foreign Application Priority Data
Dec. 13, 2024 (KR) 10-2024-0185595

(51) Int. Cl. B60H 1/32

(52) U.S. Cl. CPC B60H 1/3205; B60H 2001/3266; B60H 2001/327; B60H 2001/3285

(57) ABSTRACT

A method performed by an apparatus of a vehicle may comprise detecting, via a sensor, a leakage of a refrigerant associated with the vehicle, determining whether the vehicle is moving, and based on the detected leakage and the determining of whether the vehicle is moving, detecting, based on the vehicle being stopped, a current location of the vehicle, transmitting, based on the detected current location, a notification to a server, causing, based on the notification transmitted to the server, a customized countermeasure, and performing, based on the vehicle moving, at least one of a plurality of responses to the leakage, wherein the plurality of responses may comprise turning off an air conditioner compressor, closing an air conditioner valve, and opening an active air flap.

### CROSS-REFERENCE TO RELATED APPLICATION

This application claims the benefit of priority to Korean Patent Application No. 10-2024-0185595, filed with the Korean Intellectual Property Office on December 13, 2024, the entire contents of which are incorporated herein by reference.

### TECHNICAL FIELD

The present disclosure relates to a refrigerant leakage response device and method, and more particularly, to a refrigerant leakage response device and method of responding to a leakage of a flammable natural refrigerant.

### BACKGROUND

The matters described in this Background section are only for enhancement of understanding of the background of the disclosure, and should not be taken as acknowledgment that they correspond to prior art already known to those skilled in the art.

A leakage of a refrigerant system may be caused by pipe line vibration or corrosion. A design that prevents a leakage in advance is considered. In order to develop an indirect secondary thermal energy system to prevent refrigerant from circulating into an indoor room, reduce the amount of refrigerant (reducing the flame material) and reduce or minimize the component connection part causing a leakage, a number of components may be reduced and the components may be modularized.

R290 (propane), which is a natural refrigerant, may be eco-friendly, and may be relatively inexpensive if the thermodynamic performance is excellent. However, since such natural refrigerant may be combustible, flammable, and explosive and may be very dangerous in case of a leakage, an efficient response is considered.

### SUMMARY

The present disclosure provides a refrigerant leakage response device and method for responding to a refrigerant leakage when natural refrigerant used in a vehicle leaks.

The present disclosure also provides a refrigerant leakage response device and method for ensuring safety in response to a propane leakage when a new natural refrigerant, such as R290, is applied.

The present disclosure also provides a refrigerant leakage response device and method for responding to a refrigerant leakage in consideration of a lower flammable limit (LFL) of refrigerant concentration, a vehicle speed, a vehicle location, and a passenger.

According to the present disclosure, a method performed by an apparatus of a vehicle, the method may comprise detecting, via a sensor, a leakage of a refrigerant associated with the vehicle, determining whether the vehicle is moving, based on the detected leakage of the refrigerant and the determining of whether the vehicle is moving, detecting, based on the vehicle being stopped, a current location of the vehicle, transmitting, based on the detected current location of the vehicle, a notification to a server, and causing, based on the notification transmitted to the server, a customized countermeasure, and performing, based on the vehicle moving, at least one of a plurality of responses to the detected leakage of the refrigerant, wherein the plurality of responses may comprise turning off an air conditioner compressor of the vehicle, closing an air conditioner valve of the vehicle, and opening an active air flap of the vehicle.

The method may further comprise based on the vehicle moving, detecting a moving speed of the vehicle, and based on the moving speed of the vehicle being less than or equal to a threshold speed, limiting an output of a power train of the vehicle and operating a cooling fan, of the vehicle, with a maximum output. The method may further comprise determining whether a passenger is present inside the vehicle, performing, based on the determining of whether the passenger is present inside the vehicle, one of, based on determining no passenger being present inside the vehicle and the vehicle being stopped, stopping an operation of a heating ventilating and air conditioning (HVAC) of the vehicle and operating an air conditioning of the vehicle with an indoor air mode, or based on determining the passenger being present inside the vehicle and the vehicle moving, opening a window, operating a blower of the HVAC at a maximum capacity, and operating the air conditioning with an outdoor air mode.

The method may further comprise based on the passenger being present inside the vehicle and the vehicle moving, providing a refrigerant leakage notification to the passenger visually and audibly, and displaying a service center visit guide message. The method, wherein the causing of the customized countermeasure may comprise based on the detected current location of the vehicle being a public parking lot, turning on an emergency light of the vehicle and transmitting a danger warning notification to surrounding areas of the vehicle, and wherein the surrounding areas are within a threshold distance of the vehicle. The method, wherein the detecting of the leakage of the refrigerant may comprise based on a concentration of the refrigerant, detected via the sensor, exceeding a preset reference threshold corresponding to a specific parts-per-million (ppm) reference sensitivity value of the refrigerant, determining that the refrigerant is leaking.

The method, wherein the detecting of the leakage of the refrigerant may comprise based on the vehicle being parked, applying constant power to the sensor and periodically sensing, via the sensor, whether the refrigerant is leaking, and transmitting, via a communication circuit of the vehicle and based on the detected leakage of the refrigerant, a signal to the server. The method, wherein the transmitting of the notification to the server may comprise transmitting a notification indicating the detected leakage and the current location of the vehicle to the server.

According to the present disclosure, an apparatus of a vehicle, the apparatus may comprise a processor, and a memory storing at least one instruction that, when executed by the processor communicating with the memory, is configured to cause the apparatus to, detect, via a sensor, a leakage of a refrigerant associated with the vehicle, determine whether the vehicle is moving, based on the detected leakage of the refrigerant and the vehicle being stopped, detect a current location of the vehicle, transmit, based on the detected current location of the vehicle, a notification to a server, and cause, based on the notification transmitted to the server, a customized countermeasure, and perform, based on the vehicle moving, at least one of a plurality of responses to the detected leakage of the refrigerant, wherein the plurality of responses may comprise turning off an air conditioner compressor of the vehicle, closing an air conditioner valve of the vehicle, and opening an active air flap of the vehicle.

The apparatus, wherein the at least one instruction, when executed by the processor communicating with the memory, is configured to cause the apparatus to, based on the vehicle moving, detect a moving speed of the vehicle, and based on the moving speed of the vehicle being less than or equal to a threshold speed, limit an output of a power train of the vehicle and operate a cooling fan of the vehicle with a maximum output.

The apparatus, wherein the at least one instruction, when executed by the processor communicating with the memory, is configured to cause the apparatus to, determine whether a passenger is present inside the vehicle, based on a determination that no passenger is inside the vehicle and the vehicle being stopped, stop an operation of a heating ventilating and air conditioning (HVAC) of the vehicle and operate an air conditioning of the vehicle with an indoor air mode, and based on a determination that the passenger is present inside the vehicle and the vehicle moving, open a window, operate a blower of the HVAC at a maximum capacity, and operate the air conditioning with an outdoor air mode.

The apparatus, wherein the at least one instruction, when executed by the processor communicating with the memory, is configured to cause the apparatus to, based on the passenger being present inside the vehicle and the vehicle moving, provide a refrigerant leakage notification to the passenger visually and audibly, and display a service center visit guide message.

The apparatus, wherein the at least one instruction, when executed by the processor communicating with the memory, is configured to cause the apparatus to, provide, based on the detected current location of the vehicle and the vehicle being stopped, the customized countermeasure, and based on the current location of the vehicle being a public parking lot, turn on an emergency light of the vehicle and transmit a danger warning notification to surrounding areas of the vehicle, wherein the surrounding areas are within a threshold distance of the vehicle.

The apparatus, wherein the at least one instruction, when executed by the processor communicating with the memory, is configured to cause the apparatus to, based on a concentration of the refrigerant, detected via the sensor, exceeding a preset reference threshold corresponding to a specific parts-per-million (ppm) reference sensitivity value of the refrigerant, determine that the refrigerant is leaking. The apparatus, wherein the at least one instruction, when executed by the processor communicating with the memory, is configured to cause the apparatus to, based on the vehicle being parked, apply constant power to the sensor and periodically sense, via the sensor, whether the refrigerant is leaking, and transmit, via a communication circuit of the vehicle and based on the detected leakage of the refrigerant, a signal to the server.

The apparatus, wherein the at least one instruction, when executed by the processor communicating with the memory, is configured to cause the apparatus to transmit the notification to the server by transmitting a notification indicating the detected leakage and the current location of the vehicle to the server.

According to the present disclosure, a method performed by an apparatus for a vehicle, the method may comprise detecting, via a sensor, a leakage of a refrigerant associated with the vehicle, determining a state of the vehicle, the state indicating whether the vehicle is moving, and based on the determined state of the vehicle and the detected leakage, transmitting a refrigerant leakage notification and a current location of the vehicle to a server, and performing at least one of, turning off an air conditioner compressor of the vehicle, closing an expansion valve of the vehicle, opening an active air flap of the vehicle, or operating a cooling fan of the vehicle.

The method, wherein the determining the state of the vehicle may comprise detecting a moving speed of the vehicle, and wherein the operating of the cooling fan of the vehicle may comprise operating, based on the moving speed being less than or equal to a threshold speed, the cooling fan at a maximum output.

The method may further comprise generating a visual or audible alert within the vehicle to notify an occupant of the detected leakage. The method, wherein the detecting of the leakage may comprise comparing a detected concentration of the refrigerant to a preset threshold, and wherein the preset threshold is based on a lower flammable limit of the refrigerant.

### BRIEF DESCRIPTION OF THE DRAWINGS

FIG. 1 shows an example of a refrigerant leakage response system according to an example of the present disclosure.

FIG. 2 shows an example of a refrigerant leakage response process according to the example of the present disclosure.

FIG. 3 shows an example of a refrigerant leakage response device according to an example of the present disclosure.

FIG. 4 shows an example of a refrigerant leakage response method according to an example of the present disclosure.

FIG. 5 and FIG. 6 show an example of a refrigerant leakage response method according to an example of the present disclosure.

FIG. 7 shows an example of a computing device according to an example of the present disclosure.

### DETAILED DESCRIPTION

Hereinafter, the present disclosure will be described more fully hereinafter with reference to the accompanying drawings, in which examples of the present disclosure are shown. As those skilled in the art would realize, the described examples may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various constituent elements, but the constituent elements are not limited by the terms. The terms are used only to discriminate one constituent element from another constituent element.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

Hereinafter, examples of the present disclosure will be described in detail with reference to the accompanying drawings.

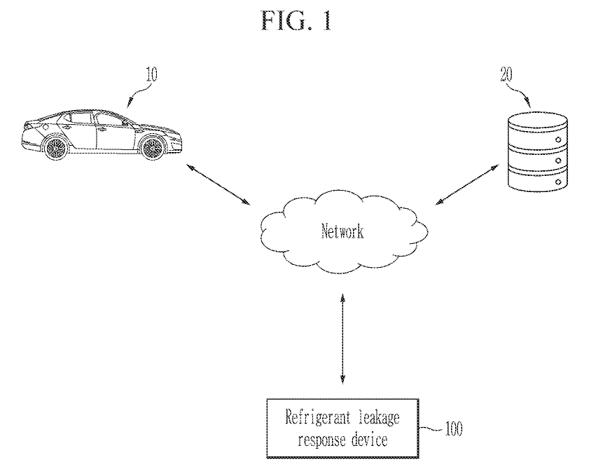

FIG. 1 shows an example of a refrigerant leakage response system according to an example of the present disclosure.

Referring to FIG. 1, a refrigerant leakage response system 1 may include a vehicle 10, a vehicle control server 20, and a refrigerant leakage response device 100 configured to detect, evaluate, and respond to refrigerant leakage events. The vehicle 10, the vehicle control server 20, and the refrigerant leakage response device 100 may be connected to each other through a wired/wireless network (e.g., Ethernet, CAN, LTE, or Wi-Fi, etc.).

The vehicle 10 may include all types of vehicles (e.g., passenger cars, trucks, buses, or electric vehicles, etc.) using an air conditioning system, such as an air conditioner using a refrigerant.

The refrigerant of a vehicle is a material used to lower the indoor temperature in an automobile air conditioner system. The refrigerant absorbs and releases heat through compression and expansion processes (e.g., within a compressor, condenser, expansion valve, and evaporator, etc.). In this process, the air is cooled as thermal energy is removed from the cabin air and transferred to the refrigerant. Refrigerants generally used in vehicles include R-12 (Freon), R-134a, R-1234yf, R744 (CO₂), R290 (propane), and the like, and R290 is increasingly used as an eco-friendly natural refrigerant.

R290 is a propane-based refrigerant and is mainly attracting attention as an eco-friendly refrigerant. R290 is a kind of hydrocarbon-based refrigerant, and has excellent refrigeration performance and a very low global warming potential (GWP). R290 is an eco-friendly and efficient refrigerant, but safety management is particularly important because of its flammability and explosion characteristics (e.g., high vapor pressure, low ignition energy, or narrow safety margin, etc.).

Lower flammable limit (LFL) or lower explosive limit (LEL) is the minimum concentration of specific flammable gas required to enable combustion in the air. For example, LFL refers to the concentration of flammable substances in the air below which ignition does not occur (e.g., due to insufficient fuel-to-air ratio, lack of sustained flame propagation, or quenching effects, etc.).

The LFL of R290 (propane) is about 2.1%. This means that when R290 in the air reaches a concentration of 2.1% or more, combustion may occur in the presence of an ignition source (e.g., a spark, a heated surface, or a static discharge, etc.).

LFL is an important factor in safety management, and ventilation and attention are required to prevent the concentration of the refrigerant in the air from exceeding LFL when refrigerant leaks (e.g., due to component failure, physical damage, or improper maintenance, etc.). Since R290 is a flammable material, leakage prevention, ventilation, and ignition source (e.g., firearm) management, need to be thoroughly implemented, and safety devices and explosion-proof facilities should be considered especially when used in an enclosed space (e.g., garages, tunnels, or underground parking lots, etc.).

The vehicle 10 may include various in-vehicle sensors that detect refrigerant leakage (e.g., gas concentration sensors, infrared detectors, or semiconductor gas sensors, etc.). The in-vehicle refrigerant leakage sensor may detect a refrigerant concentration in the air conditioning system and display the detected refrigerant concentration as a warning if the refrigerant concentration is higher than or equal to a specific concentration threshold.

The vehicle control server 20 is a system remotely connected to the vehicle 10 through a network, and may monitor and control the location, state, driving information, and the like of the vehicle in real time (e.g., using cellular, satellite, or V2X communication protocols, etc.).

The vehicle control server 20 exchanges data with the vehicle 10, and performs vehicle location tracking, driving habit analysis, route management, accident and emergency response, diagnostic analysis, and the like.

The vehicle control server 20 may include a database that stores integrated information on the vehicle 10 and stores data exchanged with the vehicle 10 through a network in real time (e.g., historical leak events, environmental conditions, or user notifications, etc.).

When a refrigerant leakage is detected, the refrigerant leakage response device 100 may perform a vehicle- or system-level response in consideration of the location of the vehicle 10, a driving speed, ambient conditions, whether the driver is on board, and the like.

The refrigerant leakage response device 100 may receive information on the refrigerant leakage from the vehicle 10 and perform vehicle control and response through the vehicle control server 20 or directly through an onboard control circuit.

The refrigerant leakage response device 100 may be implemented as a separate device as shown, or may be included as a configuration of either the vehicle 10 or the vehicle control server 20 (e.g., as an embedded control circuit, software module, or edge computing circuit, etc.).

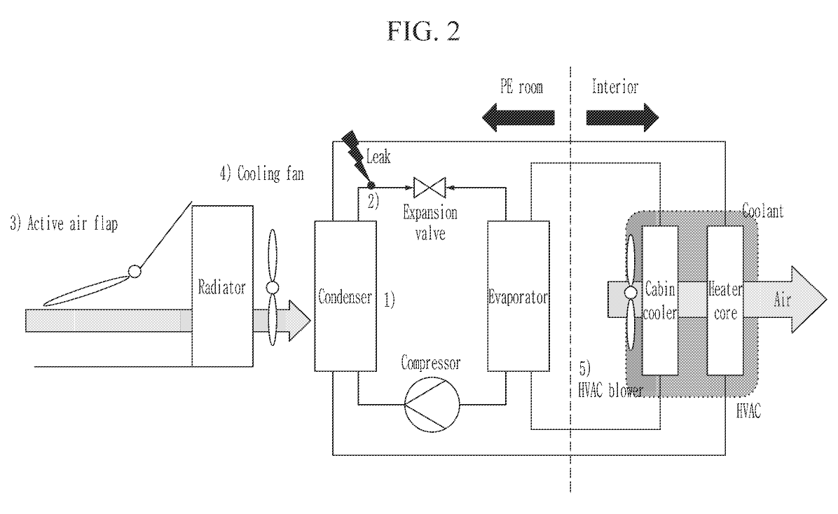

FIG. 2 shows an example of a refrigerant leakage response process according to the example of the present disclosure.

A vehicle's power electronics room (PE room) is a space that protects and manages the vehicle's electronic system (e.g., powertrain control modules, high-voltage converters, or battery interface circuits, etc.). The PE room is configured so that high voltage electronic equipment including various power conversion and control devices, such as an electric motor, a battery management system, an inverter, and a converter of the vehicle, operates safely (e.g., within thermal and electrical safety limits, etc.).

The compressor compresses the refrigerant in the vehicle air conditioning system to produce the compressed refrigerant in a high-temperature and high-pressure state. The high-pressure refrigerant becomes cold while dissipating heat from the rest of the system, and is used to supply cold air into the vehicle interior (e.g., through the evaporator and ventilation ducts, etc.).

The cooling fan and the active air flap are devices in charge of cooling so that the power conversion system of an electric vehicle or a hybrid vehicle does not overheat (e.g., under high load, rapid charging, or ambient heat conditions, etc.). The cooling fan lowers the temperature of the device by discharging high-temperature air inside the PE room to the outside or introducing cool air from the outside into the PE room (e.g., depending on vehicle speed, load conditions, or ambient temperature, etc.).

The active air flap is located at an air inlet outside the vehicle to optimize the cooling performance of the PE room and engine room to reduce the air resistance of the vehicle by controlling the air inflow (e.g., by adjusting the flap angle or opening ratio, etc.).

In other words, the cooling fan may serve to quickly cool down the high temperature, and the active air flap may play a role in reducing air resistance by controlling the inflow of external air as needed to balance aerodynamic efficiency and thermal management.

The interior of the vehicle is a space where the driver and the passenger reside in the vehicle during operation or standby.

Heating, ventilation, and air conditioning (HVAC) is a vehicle air conditioning system that integrates cooling (air conditioner), heating (heater), and ventilation systems to manage cabin comfort and air quality.

The HVAC system of the vehicle regulates the vehicle interior temperature and airflow to maintain occupant comfort and safety. The HVAC system of the vehicle includes a heater core and a cabin cooler, and serves to control cooling/heating and ventilation (e.g., by adjusting blower speed, door modes, or air mix ratios, etc.).

The heater core is in charge of heating the vehicle. The heater core has a structure similar to that of a small radiator, and provides warm air to the cabin by using heat generated when engine coolant (cooling liquid) circulates through the core fins.

A cabin cooler is a component included in a vehicle's air conditioning system and serves to keep the cabin cool mainly in hot weather. The cabin cooler acts as an evaporator and uses a refrigerant to cool the indoor air by absorbing heat during phase change.

The HVAC blower helps HVAC to circulate the vehicle's indoor air and effectively perform cooling/heating and air conditioning functions.

The HVAC blower is a fan that creates airflow and controls airflow within the HVAC system (e.g., by varying fan speed, mode selection, or airflow direction, etc.).

In FIG. 2, if refrigerant leakage is detected in the PE room, the refrigerant leakage response device 100 operates an active air flap and a cooling fan to introduce external air and lower the concentration of refrigerant (e.g., R290) in the PE room.

The refrigerant leakage response device 100 may stop the operation of the air conditioner compressor and close the expansion valve to reduce, minimize, or stop refrigerant leakage from the pressurized loop.

The refrigerant leakage response device 100 may operate the HVAC blower to discharge the refrigerant leaked into the interior of the vehicle to the outside through the outdoor air path or exhaust vent system.

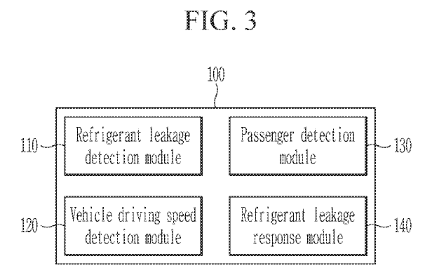

FIG. 3 shows an example of the refrigerant leakage response device according to an example of the present disclosure.

The refrigerant leakage response device 100 according to the example may execute a program code or instruction stored in one or more memory devices through one or more processors.

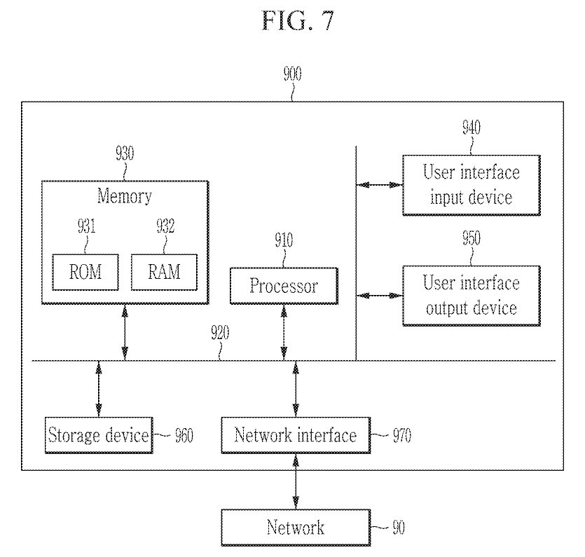

For example, the refrigerant leakage response device 100 may be implemented as a computing device 900 as described later with reference to FIG. 7. In this case, one or more processors may correspond to a processor 910 of the computing device 900, and one or more memory devices may correspond to a memory 930 of the computing device 900 (e.g., non-volatile flash memory, DRAM, or embedded storage, etc.).

The program code or instruction may be executed by one or more processors to detect and respond to a refrigerant leakage in the vehicle. In this specification, the term "module" is used to logically distinguish specific processing functions performed by a program code or instruction.

Referring to FIG. 3, the refrigerant leakage response device 100 may include a refrigerant leakage detection module 110, a vehicle driving speed detection module 120, a passenger detection module 130, and a refrigerant leakage response module 140.

The refrigerant leakage detection module 110 may detect refrigerant leakage in the vehicle cabin or system compartments. The refrigerant leakage detection module 110 may be connected to sensors in the vehicle to detect refrigerant leaking into the vehicle through the sensors (e.g., gas concentration sensors or chemical sensors, etc.).

The refrigerant leakage detection module 110 may detect whether the refrigerant leaks through a sensor.

The refrigerant leakage detection module 110 may set a reference sensitivity value having a specific ppm value of the refrigerant, and determine that the refrigerant has leaked if the detected concentration exceeds the corresponding reference sensitivity. Parts per million (PPM) is a unit representing the concentration of a substance.

If the vehicle is parked, the refrigerant leakage detection module 110 may apply constant power to a specific voltage among the 12V voltages of the vehicle and perform sensing at periodic intervals through a sensor.

Accordingly, the refrigerant leakage detection module 110 may maintain the minimum power during parking of the vehicle.

The refrigerant leakage detection module 110 may transmit a signal to a central communication unit (CCU) of a vehicle when detecting a leakage of refrigerant, and relay the signal from the CCU to an external vehicle control server through a data connectivity unit (DCU) (e.g., via cellular, Wi-Fi, or V2X communication channels, etc.).

The vehicle driving speed detection module 120 may detect whether the vehicle is driving and determine a driving speed. The vehicle driving speed detection module 120 receives vehicle driving speed information from one or more onboard sensors or ECUs of a vehicle.

The passenger detection module 130 detects whether a passenger is present inside the vehicle through an in-vehicle sensor. For example, the passenger detection module 130 may detect a passenger through an in-vehicle camera sensor or an in-vehicle seat sensor (e.g., weight sensor or occupancy detection sensor, etc.).

If a refrigerant leakage is detected, the refrigerant leakage response module 140 may perform various controls to ventilate the vehicle in consideration of the location of the vehicle, the driving speed of the vehicle, and whether a passenger is present or gets in.

The refrigerant leakage response module 140 may transmit a notification to the vehicle control server if the vehicle is stopped, and may detect the current location of the vehicle to provide a customized countermeasure based on the detected current location of the vehicle (e.g., activating a garage door, engaging a building ventilation system, or issuing alerts depending on whether the vehicle is in a private garage, public lot, or residential area, etc.).

The refrigerant leakage response module 140 may detect the current location of the vehicle in real time through a GPS of the vehicle, a separate position detection sensor, or by retrieving location information from a vehicle control server (e.g., based on navigation data, map services, or wireless network triangulation, etc.).

For example, the refrigerant leakage response module 140 may perform distinct responses depending on the location of the vehicle, such as when the vehicle is stopped outside, parked in an underground parking lot, or parked in a private garage (e.g., home garage with smart door integration, etc.).

The refrigerant leakage response module 140 may transmit a visual and audible warning notification to the outside if the vehicle is parked outside (e.g., in a driveway, roadside, or outdoor parking lot, etc.). For example, the refrigerant leakage response module 140 may turn on an emergency light and transmits a warning sound in addition to measures, such as opening a window for ventilation of a vehicle and locking an air conditioner valve if the vehicle is parked outside to prevent further refrigerant release or cabin contamination.

If the vehicle is parked in the underground parking lot, the refrigerant leakage response module 140 may transmit a notification to the vehicle control server to operate the ventilation system of the current underground parking lot through the vehicle control server (e.g., by activating exhaust fans or increasing airflow rate, etc.). For example, the refrigerant leakage response module 140 may transmit a request for the location of the underground parking lot and the operation of the ventilation system to the vehicle control server o mitigate the accumulation of leaked refrigerant in enclosed environments.

The refrigerant leakage response module 140 may ventilate the interior of the vehicle by performing at least one of a plurality of responses to turn off the air conditioner compressor, close the air conditioner valve, or open the active air flap if the vehicle is driving at or below a threshold speed where natural airflow is insufficient for dilution.

In the example, the refrigerant leakage response module 140 may perform at least one of a plurality of responses of turning off the air conditioner compressor, closing the air conditioner valve, or opening the active air flap only if the vehicle speed is equal to or below a certain speed even when motion of the vehicle is detected (e.g., during low-speed driving, idling in traffic, or approaching a stop, etc.).

In other words, the refrigerant leakage response module 140 may not perform special response logic because the refrigerant concentration decreases rapidly due to the vehicle’s motion-induced airflow (e.g., driving wind) and does not reach the LFL if the vehicle is driving at a high speed that exceeds a predetermined threshold.

If the driving speed of the vehicle is lower than a preset specific speed, the refrigerant leakage response module 140 may limit the output of the power train of the vehicle and operate the cooling fan at full capacity (e.g., a maximum output).

The refrigerant leakage response module 140 determines whether a passenger is present inside the vehicle.

If the vehicle is stopped and passengers are not detected inside the vehicle, the refrigerant leakage response module 140 may turn off the HVAC blower, operate an air conditioning indoor air mode, and turn on the emergency light to notify the outside of a warning (e.g., to pedestrians, emergency responders, or nearby vehicles, etc.).

The refrigerant leakage response module 140 may open a window, operate the HVAC blower at maximum speed, or operate an air conditioning outdoor air mode if a vehicle is driving and a passenger is detected inside the vehicle (e.g., to accelerate dilution and exhaust of leaked refrigerant, etc.).

The refrigerant leakage response module 140 may visually and aurally provide a refrigerant leakage notification to passengers if a passenger is detected inside the vehicle while the vehicle is driving, and pop-up a service center visit guide message through a display in the vehicle or a passenger's mobile terminal (e.g., via an infotainment screen or smartphone app, etc.).

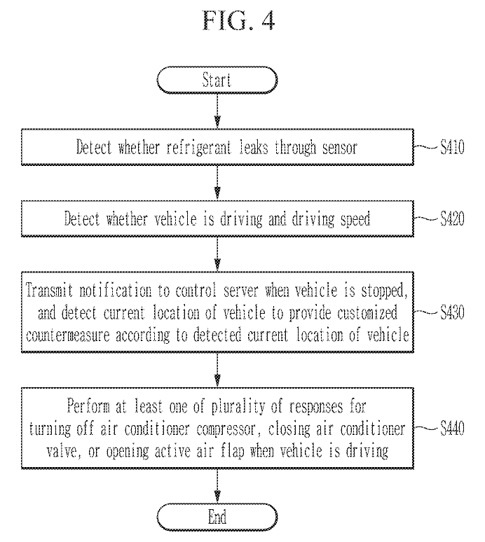

FIG. 4 shows an example of a refrigerant leakage response method according to an example of the present disclosure. The refrigerant leakage response method of FIG. 4 may be performed by the refrigerant leakage response device 100 of FIG. 1.

In FIG. 4, the refrigerant leakage response device 100 may detect whether a refrigerant leaks through a sensor (operation S410).

In operation S410, the refrigerant leakage response device 100 may determine that the refrigerant has leaked if the detected concentration of the leaked refrigerant exceeds a preset reference sensitivity threshold having a specific ppm value (e.g., 2.1% for R290, etc.).

If the vehicle is parked, the refrigerant leakage response device 100 may apply constant power to a specific voltage among 12V voltages of the vehicle and periodically monitor or sense whether the refrigerant leaks at a predetermined period through a sensor (e.g., using scheduled sampling or polling intervals, etc.).

If the leakage of refrigerant is detected, the refrigerant leakage response device 100 may transmit a signal to a central communication unit (CCU) of the vehicle, and relay the signal from the CCU to an external control server through a data connectivity unit (DCU) (e.g., using LTE, Wi-Fi, or other vehicle telematics interfaces, etc.).

The refrigerant leakage response device 100 may detect whether the vehicle is driving and determine a driving speed (operation S420). The refrigerant leakage response device 100 may receive a driving speed at which the vehicle is currently driving in real time from the vehicle (e.g., via vehicle speed sensors or electronic control units, etc.).

The refrigerant leakage response device 100 may transmit a notification to the control server if the vehicle is stopped, and may detect a current location of the vehicle to provide a customized countermeasure based on the detected current location of the vehicle (operation S430) (e.g., activating external ventilation if in a basement, sending alerts if in a residential area, etc.).

In operation S430, if the vehicle is stopped and the location of the vehicle is a public parking lot, the refrigerant leakage response device 100 may turn on the emergency light of the vehicle and visually and aurally send a danger warning notification to the surroundings (e.g., via flashing hazard lights and warning chimes, etc.).

The refrigerant leakage response device 100 may perform at least one of a plurality of responses for turning off an air conditioner compressor, closing an air conditioner valve, or opening an active air flap if the vehicle is driving (operation S440) (e.g., to suppress further refrigerant circulation, isolate the leak source, or promote ventilation, etc.).

In operation S440, the refrigerant leakage response device 100 may detect a driving speed of the vehicle if the vehicle is driving, and may limit an output of a power train of the vehicle if the driving speed of the vehicle is less than or equal to a specific speed (e.g., to reduce thermal load and minimize further refrigerant leakage risk, etc.), and perform an additional response of operating the cooling fan at a maximum capacity together with the foregoing responses.

The refrigerant leakage response device 100 may determine whether a passenger is present inside the vehicle.

If the vehicle is stopped and the passenger is not detected inside the vehicle, the refrigerant leakage response device 100 may turn off the HVAC blower to activate an air conditioning indoor air mode, and turn on the emergency light to notify the outside of a warning (e.g., to alert nearby pedestrians, maintenance personnel, or emergency responders, etc.). For example, the refrigerant leakage response device 100 executes a response strategy to prevent discharging the leaked refrigerant to the external environment.

The refrigerant leakage response device 100 may open a window, maximally operate the HVAC blower, or operate an air conditioning outdoor air mode if a vehicle is driving and a passenger is detected inside the vehicle (e.g., to ensure rapid ventilation and protect occupant safety, etc.).

The refrigerant leakage response device 100 may acquire control authority for the vehicle through a vehicle control server. Alternatively, the refrigerant leakage response device 100 may be directly connected to a control unit of the vehicle to control the vehicle (e.g., via CAN or LIN interfaces, etc.).

The refrigerant leakage response device 100 may visually and aurally provide a refrigerant leakage notification to the passenger if the passenger is detected inside the vehicle while the vehicle is driving, and may display a service center visit guide message through a vehicle display (e.g., instrument cluster, infotainment screen, or head-up display, etc.).

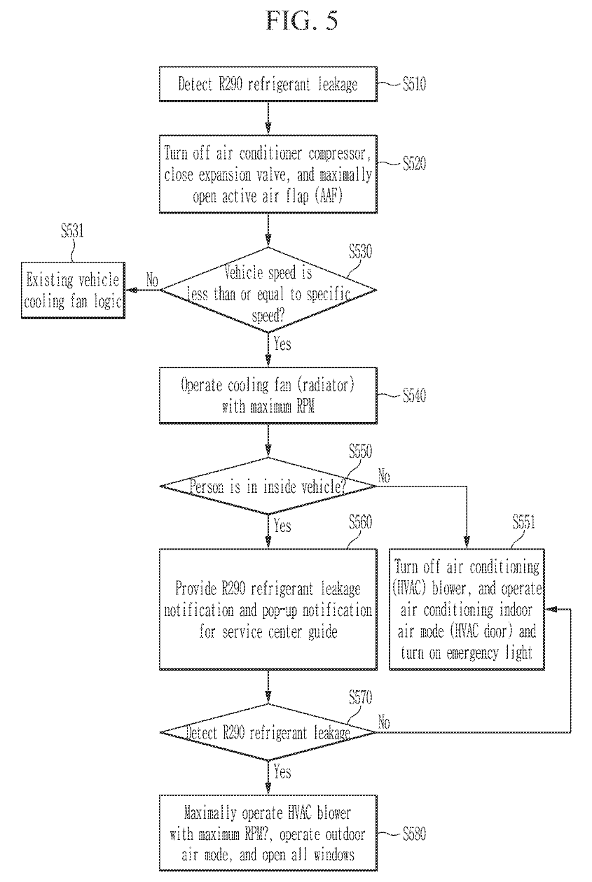

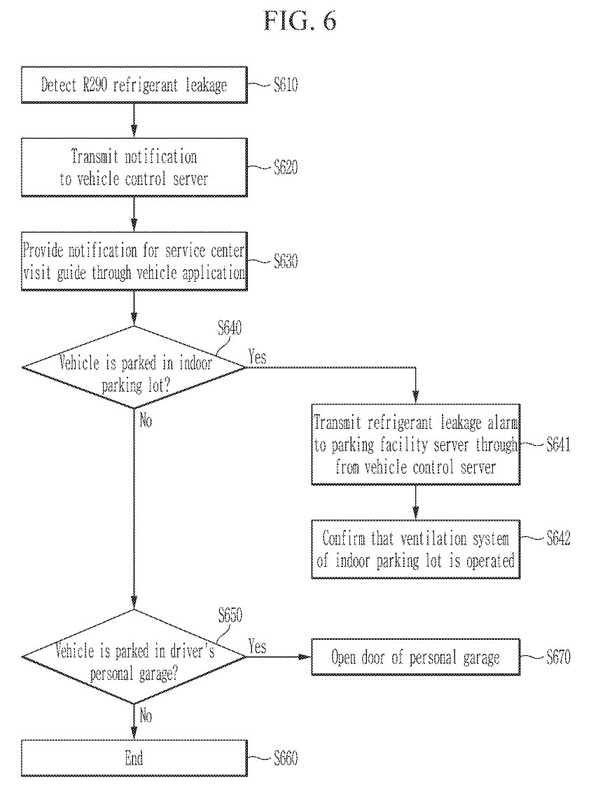

FIGS. 5 and 6 show an example of a refrigerant leakage response method according to an example of the present disclosure. The refrigerant leakage response method may be performed by the refrigerant leakage response device 100 of FIG. 1.

In FIG. 5, the refrigerant leakage response device 100 may detect an R290 refrigerant leakage through an in-vehicle sensor (operation S510).

If it is determined that the refrigerant has leaked, the refrigerant leakage response device 100 may turn off an air conditioner compressor, close an expansion valve, and operate an active air flap to its maximum value (operation S520) (e.g., to isolate the refrigerant flow and promote rapid ventilation of leaked gas, etc.).

Thereafter, the refrigerant leakage response device 100 may determine whether the vehicle speed is less than or equal to a specific speed (operation S530) (e.g., a threshold below which natural airflow is insufficient to disperse leaked refrigerant, etc.). The specific speed may be determined as a predetermined speed, and may be determined as a concentration at which the concentration of the refrigerant leaking from the vehicle is not reduced by the driving wind (e.g., below 20 km/h, depending on vehicle design, etc.).

If the vehicle speed exceeds a specific speed, the refrigerant leakage response device 100 may maintain a current cooling fan operation state of the vehicle (operation S531).

The refrigerant leakage response device 100 may operate the RPM of the cooling fan of the vehicle to a maximum value if the vehicle speed is less than or equal to the specific speed (operation S540) (e.g., to rapidly ventilate the PE room or engine bay, etc.).

The refrigerant leakage response device 100 may determine whether a person is present inside the vehicle (operation S550) (e.g., using seat sensors, infrared detection, or occupant cameras, etc.).

The refrigerant leakage response device 100 may stop the operation of the HVAC blower if no person is present inside, and may operate the air conditioning indoor air mode to prevent external discharge of leaked refrigerant and turn on the emergency light (operation S551) (e.g., to visually alert nearby individuals or responders, etc.). For example, the refrigerant leakage response device 100 prevents the refrigerant leaking into the interior from being discharged to the outside, for example, where it could pose a fire or safety hazard.

If a person is present in the interior, the refrigerant leakage response device 100 provides an R290 refrigerant leakage notification and a pop-up notification for a service center guide on the interior of the vehicle (operation S560) (e.g., via an infotainment display or mobile device pairing, etc.).

The refrigerant leakage response device 100 may continuously detect a refrigerant leakage (operation S570) (e.g., through periodic sensor polling or real-time monitoring to track changes in concentration, etc.).

The refrigerant leakage response device 100 may maximally operate the HVAC blower if it is detected that the person is present inside the vehicle and the refrigerant leakage is detected, operate the air conditioning outdoor air mode, and open one or more windows, or all windows (operation S580) (e.g., to evacuate contaminated air and reduce or minimize occupant exposure, etc.).

In FIG. 6, if the refrigerant leakage is detected (operation S610), the refrigerant leakage response device 100 may transmit a notification to the vehicle control server (operation S620) (e.g., via cellular, Wi-Fi, or V2X communication, etc.).

The refrigerant leakage response device 100 may simultaneously provide a vehicle interior refrigerant leakage notification and a service center visit guide pop-up through a vehicle application (app), a cluster, or infotainment (operation S630) (e.g., via a center display, instrument panel, or mobile phone integration, etc.).

The refrigerant leakage response device 100 may determine whether the vehicle is parked in an indoor parking lot (operation S640) (e.g., based on GPS coordinates, building entry detection, or facility Wi-Fi or beacon signals, etc.). The refrigerant leakage response device 100 may determine whether the vehicle is parked in the indoor parking lot through GPS in the vehicle or location information of the vehicle stored in the vehicle control server (e.g., using map data or geofencing, etc.). The indoor parking lot may be a public parking lot (e.g., commercial garages, shopping mall parking structures, etc.) or private facility.

If it is determined that the vehicle is parked in the indoor parking lot, the refrigerant leakage response device 100 may transmit a refrigerant leakage alarm to the parking lot or a parking facility server through the vehicle control server (operation S641) (e.g., requesting fan activation or garage ventilation control, etc.).

The refrigerant leakage response device 100 may confirm that a ventilation system of the indoor parking lot is operated (operation S642) (e.g., by receiving a signal from the parking facility server, detecting airflow through onboard sensors, or polling IoT-connected infrastructure, etc.). The refrigerant leakage response device 100 may check whether the ventilation system of the indoor parking lot is operated through a sensor of the vehicle or via communication with a vehicle control server (e.g., by monitoring airflow rate or fan status, etc.).

The refrigerant leakage response device 100 may continuously transmit a leakage alarm to the indoor parking facility server until the operation of the ventilation system of the indoor parking lot is confirmed (e.g., by receiving confirmation signals or sensor readings indicating air circulation is active at regular intervals or until a positive acknowledgment is received, etc.).

The refrigerant leakage response device 100 may determine whether the vehicle is parked in a driver's personal garage other than an indoor parking lot (operation S650) (e.g., based on geofencing data, Wi-Fi SSID recognition, or visual markers captured by onboard cameras, etc.). The refrigerant leakage response device 100 may determine whether the vehicle is parked in the garage through a camera sensor or a GPS of the vehicle (e.g., using garage door sign-in data, using geofencing or visual pattern recognition, etc.).

If it is determined that the vehicle is parked in the personal garage, the refrigerant leakage response device 100 may open a door of the personal garage (operation S670) (e.g., via a wireless command to a smart garage opener or home automation hub, etc.). The refrigerant leakage response device 100 may be connected to a door opening/closing system of the personal garage through a network (e.g., Wi-Fi, Zigbee, IoT gateway, or proprietary garage control systems, etc.). The refrigerant leakage response device 100 may control opening and closing of the door of the personal garage if necessary through the network (e.g., via secure wireless protocols such as Wi-Fi, Zigbee, or Bluetooth, etc.).

Unless the vehicle is parked in the personal garage, the refrigerant leakage response device 100 may terminate the corresponding logic (operation S660). The corresponding logic of FIG. 6 according to the determination of whether the vehicle is driving may be performed (e.g., switching to a motion-based response protocol, etc.).

FIG. 7 shows an example of a computing device according to an example of the present disclosure.

Referring now to FIG. 7, the refrigerant leakage response device and method according to the examples may be implemented by using a computing device 900.

The computing device 900 may include at least one of a processor 910, a memory 930, a user interface input device 940, a user interface output device 950, and a storage device 960 communicating via a bus 920. The computing device 900 may also include a network interface 970 that is electrically connected to a network 90. The network interface 970 may transmit or receive a signal with another entity through the network 90.

The processor 910 may be implemented in various types, such as a Micro Controller Unit (MCU), an Application Processor (AP), a Central Processing Unit (CPU), a Graphic Processing Unit (GPU), a Neural Processing Unit (NPU), and the like, and may be a predetermined semiconductor device executing commands stored in the memory 930 or the storage device 960. The processor 910 may be configured to implement the functions and the methods described above with reference to FIG. 1, FIG. 2, FIG. 3, FIG. 4, and FIG. 6 (e.g., signal detection, condition evaluation, and actuator control, etc.).

The memory 930 and the storage device 960 may include various forms of volatile or non-volatile storage media. For example, the memory may include a Read Only Memory (ROM) 931 and a Random Access Memory (RAM) 932. In the example, the memory 930 may be located inside or outside the processor 910, and the memory 930 may be connected with the processor 910 through various interconnect architectures.

In some examples, at least some configurations or functions of the refrigerant leakage response device and method according to the examples may be implemented as programs or software executed on the computing device 900, and the programs or software may be stored on a computer-readable medium (e.g., flash memory, solid-state drives, or removable storage, etc.).

An example of the present disclosure provides a refrigerant leakage response method including: detecting a leakage of a refrigerant through a sensor; detecting whether a vehicle is driving; when the leakage of the refrigerant is confirmed, transmitting a notification to a control server when the vehicle is stopped, and detecting a current location of the vehicle to provide a customized countermeasure according to the detected current location of the vehicle; and performing at least one of a plurality of responses to turn off an air conditioner compressor, close an air conditioner valve, or open the active air flap when the vehicle is driving.

In the example, the refrigerant leakage response method may further include: when the vehicle is driving, detecting a driving speed of the vehicle; and when the driving speed of the vehicle is less than or equal to a specific speed, limiting an output of a power train of the vehicle and operating a cooling fan with a maximum output.

In the example, the refrigerant leakage response method may further include: determining whether a passenger is present inside the vehicle; when it is detected that there is no passenger inside the vehicle while the vehicle is stopped, stopping an operation of a heating ventilating and air conditioning (HVAC) and operating an air conditioning indoor air mode; and when it is detected that the passenger is present inside the vehicle while the vehicle is driving, opening a window, maximally operating an HVAC blower, and operating an air conditioning outdoor air mode.

In the example, the refrigerant leakage response method may further include when it is detected that the passenger is present inside the vehicle while the vehicle is driving, providing a refrigerant leakage notification to the passenger visually and audibly, and popping up a service center visit message.

The providing of the customized countermeasure according to the detected current location of the vehicle when the vehicle is stopped may include when a location of the vehicle is a public parking lot, turning on an emergency light of the vehicle and transmitting a danger warning notification to surroundings.

The detecting of the leakage of a refrigerant through the sensor may include determining that the refrigerant leaks when sensitivity exceeds a preset reference sensitivity having a specific ppm value of the refrigerant.

The detecting of the leakage of a refrigerant through the sensor may include: when the vehicle is parked, applying constant power to a specific voltage of vehicle's 12V voltage and sensing whether the refrigerant leaks at regular intervals through the sensor; and transmitting a signal to a central communication unit (CCU) of the vehicle when it is detected that the refrigerant leaks and transmitting a signal from the CCU to an external control server through a data connectivity unit (DCU).

Another example of the present disclosure provides a refrigerant leakage response device for detecting and responding to a refrigerant leakage of a vehicle by executing a program code stored in one or more memory devices through one or more processors, in which the program code is executed to detect a leakage of a refrigerant through a sensor, detect whether a vehicle is driving, when the leakage of the refrigerant is confirmed, transmit a notification to a control server when the vehicle is stopped, and detect a current location of the vehicle to provide a customized countermeasure according to the detected current location of the vehicle, and perform at least one of a plurality of responses to turn off an air conditioner compressor, close an air conditioner valve, or open the active air flap when the vehicle is driving.

When the vehicle is driving, the refrigerant leakage response device detects a driving speed of the vehicle, and when the driving speed of the vehicle is less than or equal to a specific speed, the refrigerant leakage response device may limit an output of a power train of the vehicle and operate a cooling fan with a maximum output.

The refrigerant leakage response device may determine whether a passenger is present inside the vehicle, and when it is detected that there is no passenger inside the vehicle while the vehicle is stopped, the refrigerant leakage response device may stop an operation of a heating ventilating and air conditioning (HVAC) and operate an air conditioning indoor air mode, and when it is detected that the passenger is present inside the vehicle while the vehicle is driving, opening a window, the refrigerant leakage response device may maximally operate an HVAC blower, and operate an air conditioning outdoor air mode.

When it is detected that the passenger is present inside the vehicle while the vehicle is driving, the refrigerant leakage response device may provide a refrigerant leakage notification to the passenger visually and audibly, and pop up a service center visit guide message.

The providing of the customized countermeasure according to the detected current location of the vehicle when the vehicle is stopped may include when a location of the vehicle is a public parking lot, turning on an emergency light of the vehicle and transmitting a danger warning notification to surroundings.

The detecting of the leakage of a refrigerant through the sensor may include setting a reference sensitivity having a specific ppm value, and determining that the refrigerant leaks when sensitivity exceeds the corresponding reference sensitivity.

The detecting of the leakage of a refrigerant through the sensor may include, when the vehicle is parked, applying constant power to a specific voltage of vehicle's 12V voltage and sensing whether the refrigerant leaks at regular intervals through the sensor, and transmitting a signal to a central communication unit (CCU) of the vehicle when it is detected that the refrigerant leaks and transmitting a signal from the CCU to an external control server through a data connectivity unit (DCU).

According to the examples of the present disclosure, the refrigerant leakage response device and method may immediately respond to a leakage of a combustible natural refrigerant used in the vehicle in consideration of a refrigerant concentration lower flammable limit (LFL), a vehicle speed, a vehicle location, and a passenger to prevent a risk.

In some examples, at least some configurations or features of the refrigerant leakage response device and method according to the examples may be implemented using hardware or circuit of the computing device 900, or may be implemented as separate hardware or circuit that may be electrically connected to computing device 900.

Although the above examples of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. A method performed by an apparatus of a vehicle, the method comprising:
detecting, via a sensor, a leakage of a refrigerant associated with the vehicle;
determining whether the vehicle is moving;
based on the detected leakage of the refrigerant and the determining of whether the vehicle is moving:
detecting, based on the vehicle being stopped, a current location of the vehicle,
transmitting, based on the detected current location of the vehicle, a notification to a server, and causing, based on the notification transmitted to the server, a customized countermeasure; and
performing, based on the vehicle moving, at least one of a plurality of responses to the detected leakage of the refrigerant, wherein the plurality of responses comprises:
turning off an air conditioner compressor of the vehicle,
closing an air conditioner valve of the vehicle, and
opening an active air flap of the vehicle.

2. The method of claim 1, further comprising:
based on the vehicle moving, detecting a moving speed of the vehicle; and
based on the moving speed of the vehicle being less than or equal to a threshold speed, limiting an output of a power train of the vehicle and operating a cooling fan, of the vehicle, with a maximum output.

3. The method of claim 1, further comprising:
determining whether a passenger is present inside the vehicle;
performing, based on the determining of whether the passenger is present inside the vehicle, one of:
based on determining no passenger being present inside the vehicle and the vehicle being stopped, stopping an operation of a heating ventilating and air conditioning (HVAC) of the vehicle and operating an air conditioning of the vehicle with an indoor air mode; or
based on determining the passenger being present inside the vehicle and the vehicle moving, opening a window, operating a blower of the HVAC at a maximum capacity, and operating the air conditioning with an outdoor air mode.

4. The method of claim 3, further comprising:
based on the passenger being present inside the vehicle and the vehicle moving, providing a refrigerant leakage notification to the passenger visually and audibly, and displaying a service center visit guide message.

5. The method of claim 1, wherein the causing of the customized countermeasure comprises, based on the detected current location of the vehicle being a public parking lot, turning on an emergency light of the vehicle and transmitting a danger warning notification to surrounding areas of the vehicle, and
wherein the surrounding areas are within a threshold distance of the vehicle.

6. The method of claim 1, wherein the detecting of the leakage of the refrigerant comprises:
based on a concentration of the refrigerant, detected via the sensor, exceeding a preset reference threshold corresponding to a specific parts-per-million (ppm) reference sensitivity value of the refrigerant, determining that the refrigerant is leaking.

7. The method of claim 1, wherein the detecting of the leakage of the refrigerant comprises:
based on the vehicle being parked, applying constant power to the sensor and periodically sensing, via the sensor, whether the refrigerant is leaking; and
transmitting, via a communication circuit of the vehicle and based on the detected leakage of the refrigerant, a signal to the server.

8. The method of claim 1, wherein the transmitting of the notification to the server comprises transmitting a notification indicating the detected leakage and the current location of the vehicle to the server.

9. An apparatus of a vehicle, the apparatus comprising:
a processor; and
a memory storing at least one instruction that, when executed by the processor communicating with the memory, is configured to cause the apparatus to:
detect, via a sensor, a leakage of a refrigerant associated with the vehicle,
determine whether the vehicle is moving,
based on the detected leakage of the refrigerant and the vehicle being stopped,
detect a current location of the vehicle,
transmit, based on the detected current location of the vehicle, a notification to a server, and
cause, based on the notification transmitted to the server, a customized countermeasure, and
perform, based on the vehicle moving, at least one of a plurality of responses to the detected leakage of the refrigerant, wherein the plurality of responses comprises:
turning off an air conditioner compressor of the vehicle,
closing an air conditioner valve of the vehicle, and
opening an active air flap of the vehicle.

10. The apparatus of claim 9, wherein the at least one instruction, when executed by the processor communicating with the memory, is configured to cause the apparatus to,
based on the vehicle moving, detect a moving speed of the vehicle, and
based on the moving speed of the vehicle being less than or equal to a threshold speed, limit an output of a power train of the vehicle and operate a cooling fan of the vehicle with a maximum output.

11. The apparatus of claim 9, wherein the at least one instruction, when executed by the processor communicating with the memory, is configured to cause the apparatus to:
determine whether a passenger is present inside the vehicle,
based on a determination that no passenger is inside the vehicle and the vehicle being stopped, stop an operation of a heating ventilating and air conditioning (HVAC) of the vehicle and operate an air conditioning of the vehicle with an indoor air mode, and
based on a determination that the passenger is present inside the vehicle and the vehicle moving, open a window, operate a blower of the HVAC at a maximum capacity, and operate the air conditioning with an outdoor air mode.

12. The apparatus of claim 11, wherein the at least one instruction, when executed by the processor communicating with the memory, is configured to cause the apparatus to: based on the passenger being present inside the vehicle and the vehicle moving,
provide a refrigerant leakage notification to the passenger visually and audibly, and
display a service center visit guide message.

13. The apparatus of claim 9, wherein the at least one instruction, when executed by the processor communicating with the memory, is configured to cause the apparatus to:
provide, based on the detected current location of the vehicle and the vehicle being stopped, the customized countermeasure, and
based on the current location of the vehicle being a public parking lot, turn on an emergency light of the vehicle and transmit a danger warning notification to surrounding areas of the vehicle, wherein the surrounding areas are within a threshold distance of the vehicle.

14. The apparatus of claim 9, wherein the at least one instruction, when executed by the processor communicating with the memory, is configured to cause the apparatus to:
based on a concentration of the refrigerant, detected via the sensor, exceeding a preset reference threshold corresponding to a specific parts-per-million (ppm) reference sensitivity value of the refrigerant, determine that the refrigerant is leaking.

15. The apparatus of claim 9, wherein the at least one instruction, when executed by the processor communicating with the memory, is configured to cause the apparatus to:
based on the vehicle being parked, apply constant power to the sensor and periodically sense, via the sensor, whether the refrigerant is leaking, and
transmit, via a communication circuit of the vehicle and based on the detected leakage of the refrigerant, a signal to the server.

16. The apparatus of claim 9, wherein the at least one instruction, when executed by the processor communicating with the memory, is configured to cause the apparatus to transmit the notification to the server by transmitting a notification indicating the detected leakage and the current location of the vehicle to the server.

17. A method performed by an apparatus for a vehicle, the method comprising:
detecting, via a sensor, a leakage of a refrigerant associated with the vehicle;
determining a state of the vehicle, the state indicating whether the vehicle is moving; and
based on the determined state of the vehicle and the detected leakage:
transmitting a refrigerant leakage notification and a current location of the vehicle to a server; and
performing at least one of:
turning off an air conditioner compressor of the vehicle,
closing an expansion valve of the vehicle,
opening an active air flap of the vehicle, or
operating a cooling fan of the vehicle.

18. The method of claim 17, wherein the determining the state of the vehicle comprises detecting a moving speed of the vehicle, and wherein the operating of the cooling fan of the vehicle comprises operating, based on the moving speed being less than or equal to a threshold speed, the cooling fan at a maximum output.

19. The method of claim 17, further comprising generating a visual or audible alert within the vehicle to notify an occupant of the detected leakage.

20. The method of claim 17, wherein the detecting of the leakage comprises comparing a detected concentration of the refrigerant to a preset threshold, and wherein the preset threshold is based on a lower flammable limit of the refrigerant.
